(19) United States
(12) Patent Application Publication
(10) Pub. No.: US 2018/0010773 A1
(43) Pub. Date: Jan. 11, 2018

(54) DYNAMIC LIGHT SCATTERING DEVICE AND LIGHTING DEVICE INCLUDING THE SAME

(71) Applicant: Q-sys Co., Ltd., Gwangju (KR)

(72) Inventors: Akihiro MOCHIZUKI, Louisville, CO (US); Yang-Bae KIM, Gwangju (KR); Jung-Dae CHO, Gwangju (KR)

(73) Assignee: Q-sys Co., Ltd., Gwangju (KR)

(21) Appl. No.: 15/201,986

(22) Filed: Jul. 5, 2016

(51) Int. Cl. F21V 14/00; G02F 1/137

(52) U.S. Cl. CPC F21V 14/003; G02F 1/137; F21Y 2115/10; G02F 2001/13756

(57) ABSTRACT

An electrically controllable light distribution pattern lighting fixture technology is disclosed. This technology consists of an LED light emitting source, a light scattering/defusing liquid crystal device and its electrical driving controller. This technology enables uniform scattered/defusing emitted light pattern from LED light sources and dimming without sacrificing LED light emission coloration, hue and other characteristics.

### FIELD OF THE INVENTION

The present invention relates to electrically controllable distribution and dimming of light emitted from a light emitting diode (LED) source.

### BACKGROUND OF THE INVENTION

Recent technical and market trends have created a need to increase energy efficiency of light illumination devices, such as lighting fixtures, display back light units, and the like. To reduce power consumption, fluorescent tubes are being replaced by LED light bulbs in most lighting fixtures connected to power lines. LED light sources distribute light over a narrower angle than fluorescent tubes. Acrylic light diffusing plates are commonly used with fluorescent tubes to diffuse fluorescent light over a wide angle. Acrylic light diffusing plates may be used with LED bulbs, but are insufficient to eliminate “bright spots” at the primary emission angle of the LED light source. Therefore, LED light bulbs require a more effective means of distributing light uniformly to be used as a light fixture.

The most popular lighting fixture for an office use is ceiling implemented fluorescence light with an acrylic light diffusing plate as described in U.S. Pat. No. 6,024,465. A certain structured and/or pattern printed acrylic resin plate diffuses light emitted from a rod-like emitting fluorescent light bulb to wide angle diffused light. Due to the diffusing function of the acrylic plate, the brightness of the surface of the lighting fixture appears the same without showing so-called bright lines in the lighting fixture. Most such ceiling lights are required to diffuse light bulb emission from rod-shape or point-shape sources to wide area emission shape as uniformly as possible.

Unlike rod-shaped emitting fluorescent light sources, bullet type or point-shaped LED sources require more effective light scattering than fluorescent light source. Some illumination applications using point-shaped LEDs implement linear arrays of bullet type of LEDs as shown in FIG. 1. In such linear array light sources, the same light defusing plate widely used for fluorescent light source is theoretically applicable. However, due to the strong emission of point-shaped LED light bulbs, the fixture still shows so-called “bright spots” at each LED valve position of the linear array. To avoid such bright spots and to have a uniform emitting area emission lighting fixture, a more effective means of light scattering is required.

LED light bulbs emit light more efficiently than traditional incandescent light bulbs and fluorescent tubes. Therefore, LED light bulbs require effective dimming to be used as a light fixture. Currently, LED light bulbs are dimmed either by current adjustment or pulse width modulation. Unlike incandescent bulbs, the color of LED light bulbs is sensitive to current adjustment. Further, LED light bulbs require a minimum current to emit light, restricting the range in which current adjustment is possible. Therefore, pulse width modulation is commonly used to dim LED light bulbs. However, pulse width modulation requires additional electronic circuitry, increasing cost and power consumption. Additionally, concerns exist as to possible harmful effects of pulse width modulation on human health. Therefore, an effective means of dimming LED light bulbs is necessary without compromising light emission efficiency.

In some instances the narrow emission angle of LED light bulbs is desirable. For commercial uses such as retail shop illumination, this characteristic is attractive for the design of decorative light fixtures. Unlike home and office lighting applications where wide, uniform light distribution is necessary, pin-point illumination is effective for display and decorative lighting in a variety of retail shops, restaurants, and public areas. Even in these instances, active control over light diffusion and dimming is still desirable.

In addition to structured and/or specific pattern printed acrylic board, U.S. Pat. No. 5,645,758 discloses a light scattering technology using small particles of a specific size. This technology teaches the use of small particles to induce light scattering as shown in FIG. 2. As illustrated in FIG. 2, this technology enables an effective light scattering by dispersing small particles of a specific size in a transparent sustaining medium such as liquid crystal material. However, similar to structured or printed acrylic plate technology, this light scattering mechanism is basically same in terms of use of a fixed size of the light diffusing vehicle. Although U.S. Pat. No. 5,645,758 teaches the use of liquid crystal material for the purpose of light scattering, the liquid crystal material is for electric field response only, and the light scattering/defusing function is not performed by the liquid crystal material, but by the dispersed fixed size of rod-shaped material. When light scattering/defusing is provided by plate shaped particles, the light scattering/defusing performance is controlled only by the density, size, and shape of plate shaped dopant. Therefore, such light scattering/defusing properties are similar to that of a fixed acrylic plate. Both a conventional light scattering acrylic plate and technology of U.S. Pat. No. 5,645,758 give an effective light scattering for LED light bulbs. However, these fixed light scattering technologies do not allow for active light scattering control. Active light scattering means light scattering pattern control by electrical means. Additionally, such fixed light scattering methods do not permit active control of light intensity or dimming.

Another well-known approach for light scattering/diffusion is a back light unit for liquid crystal display device. A typical structure of a back light unit for a liquid crystal display device is disclosed in U.S. Pat. No. 9,299,743. FIG. 3 illustrates a typical back light unit structure as described in U.S. Pat. No. 9,299,743. Although the technical purpose of these applications is to have uniform area light intensity, the liquid crystal device back light unit uses an edge light source to conserve space, unlike overhead lighting fixtures. For this reason, back light units need to change light direction from an edge or cross sectional direction to a vertical direction as shown in FIG. 3. Therefore, such back light units require not only a light scattering property, but also a light guiding property. In some sense, these two properties are contradictory. However, such contradictory properties are optimized by continuous change of the refractive index of the light wave guide board. This continuous change of the refractive index suggests a means for uniform light illumination in a certain area. However, back light units for liquid crystal devices aim toward focused lighting, or non-diffusing light illumination, to provide sufficient light intensity to the screen of the display for greater light efficiency. This results in significantly different performance than lighting fixtures, since lighting fixtures require area uniform light intensity as diffused or scattered light. Each light flux from the lighting fixture should have a variety of directions, enabling so-called soft ambient light with bright intensity. In the case of back light unit for liquid crystal device, each light flux should be aligned or collimated. These different purposes result in significantly different designs for light modulation for back light units and lighting fixtures.

A different approach for controlling light intensity using a liquid crystal panel is disclosed in US Patent Application Publication US 2014/0226096. This approach is similar to the published paper “Liquid Crystal Windows for Advanced Facades” SID (Society for Information Display) Symposium technical Digest pp. 376-378, paper No. 30-1 (2016). These approaches use light absorption to control the light throughput of liquid crystal panels. Functionally, this approach is similar to electrochromic windows. These approaches, using either light absorption with dye in a liquid crystal panel or electrochromic glass, are based on light absorption to dim light throughput and such light absorption does not afford a light scattering pattern control function.

### SUMMARY OF THE INVENTION

The present invention relates to an electrically controllable liquid crystal device to control the diffusion and dimming of light emitted from an LED source. Widespread use of LED light bulbs in overhead lighting applications require an effective means of diffusing light from an LED source. This invention is directed to providing more effective light diffusion than conventional light diffusing acrylic plates.

LED light bulbs have greater light emission efficiency than incandescent and fluorescent light bulbs relative to power consumption. However, LED light bulbs present two technical difficulties to overcome.

First, the light emission area for inorganic LED light bulbs is small. Organic LED light sources have improved area emission compared to inorganic LED light sources, but present additional technical problems. Current point emission LED light bulbs use arrays of point emission LEDs to achieve improved area emission. Therefore, total power consumption over a large area increases despite the relative efficiency of each discrete LED source. Improved lighting requires an effective uniform area emitting light fixture.

Second, dimming of LED light bulbs is difficult. Currently there are two primary methods used for dimming of LED light bulbs. One method is current adjustment. However, LED light bulbs require a minimum current for light emission. Therefore, there is a limit to the range of dimming that can be achieved by current adjustment. A second method is pulse width modulation. However, pulse width modulation requires additional circuitry. LEDs require current control rather than voltage control, increasing the complexity of pulse width modulation control circuitry, increasing cost and power consumption.

Light fixtures consisting of LED arrays also require a more effective diffusion technique than provided by structured or dot-printed acrylic plates.

An active, electrically controlled light diffusion system overcomes these difficulties. Unlike conventional light scattering/diffusing methods, active control of light scattering is provided in some embodiments. Unlike known light scattering/diffusing methods, electrically controllable changes of light scattering patterns are achieved in some embodiments. Electrical control allows for the alteration of the light emission distribution pattern from a fixed light source. A specific type of light scattering liquid crystal device is used in some embodiments. The effective light scattering/diffusion property of a liquid crystal device is utilized to achieve active control of diffusion and dimming of light from an LED source. Also, dynamic light distribution and dimming while light emission from an LED source remains constant is achieved, eliminating the need for current adjustment or pulse width modulation.

### BRIEF DESCRIPTION OF THE DRAWINGS

FIG. 1 illustrates a conventional LED linear array structure.

FIG. 2 illustrates a method of light scattering control with plate-shaped particles in a liquid crystal mixture.

FIG. 3 illustrates an exemplary back light unit structure for flat panel displays.

FIG. 4(a) illustrates light transmission through a deactivated light scattering liquid crystal device.

FIG. 4(b) illustrates light scattering through an activated light scattering liquid crystal device.

FIGS. 4(c) and 4(d) illustrates light pattern manipulation when the light scattering liquid crystal device is not activated.

FIG. 4(e) illustrates dynamic light scattering by the liquid crystal device when the device is activated by an applied voltage.

FIG. 5(a) illustrates a measurement set up for measuring the light scattering/diffusion pattern of a conventional LED light bulb.

FIG. 5(b) illustrates a measurement set up for measuring the light scattering/diffusion pattern for an LED light bulb with the electrically controlled, light scattering liquid crystal device of this invention.

FIG. 6 illustrates the relative light intensity of a conventional LED light bulb measured across viewing angle.

FIG. 7 illustrates a cross sectional view of the light scattering liquid crystal device in an embodiment of this invention.

FIG. 8 illustrates the chemical formula for a laterally fluorinated nematic single liquid crystal.

FIG. 9 illustrates the relative light intensity of an LED light bulb with a dynamic scattering mode liquid crystal device with no applied voltage measured across viewing angle.

FIG. 10 illustrates the relative light intensity of an LED light bulb with a dynamic scattering mode liquid crystal device driven by a 30 Hz, 10 V rectangular waveform voltage measured across viewing angle.

FIG. 11 illustrates the relative light intensity of an LED light bulb with a dynamic scattering mode liquid crystal device driven by a 30 Hz, 20 V rectangular waveform voltage measured across viewing angle.

FIG. 12 illustrates the relative light intensity of an LED light bulb with a dynamic scattering mode liquid crystal device driven by a 30 Hz, 30 V rectangular waveform voltage measured across viewing angle.

FIG. 13 illustrates the relative light intensity of an LED light bulb with a dynamic scattering mode liquid crystal device driven by a 30 Hz, 40 V rectangular waveform voltage measured across viewing angle.

FIG. 14 illustrates the creation of multiple, regularly space light spots from a single light source using light diffraction by a light scattering liquid crystal device.

FIG. 15 illustrates a light fixture with an E26 socket LED light bulb, a light reflector/corrector, and an electrically controlled, light scattering liquid crystal device.

FIG. 16 illustrates an electrically controlled, light scattering/diffusion device with an automatic ambient light detector.

FIG. 17 illustrates a light fixture with an E26 socket LED light bulb, a light reflector/corrector, and multiple electrically controlled, light scattering liquid crystal devices.

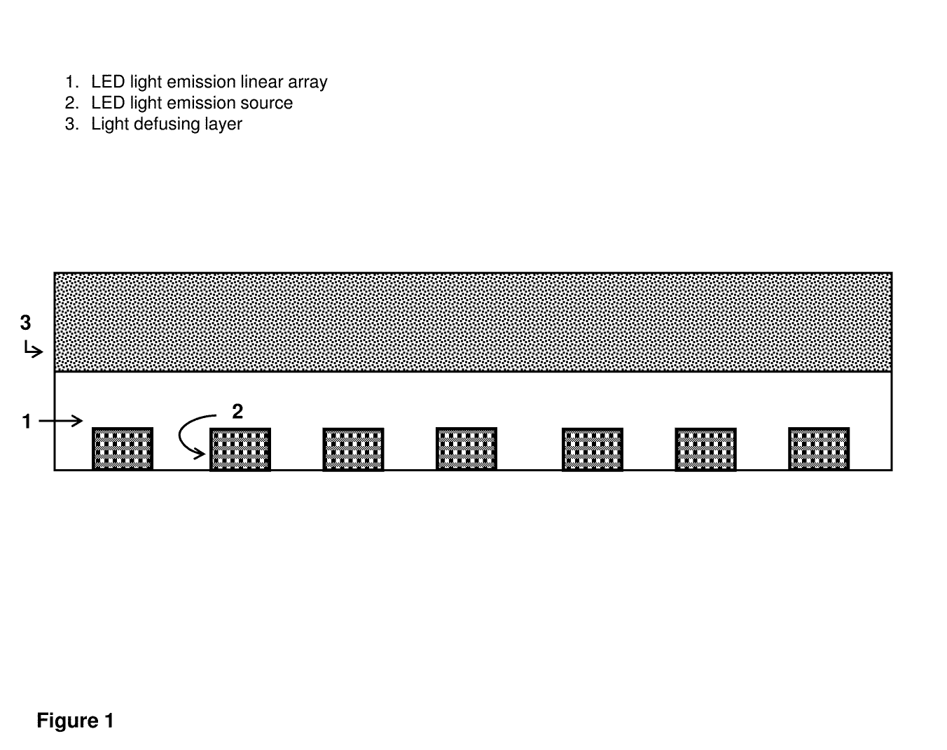

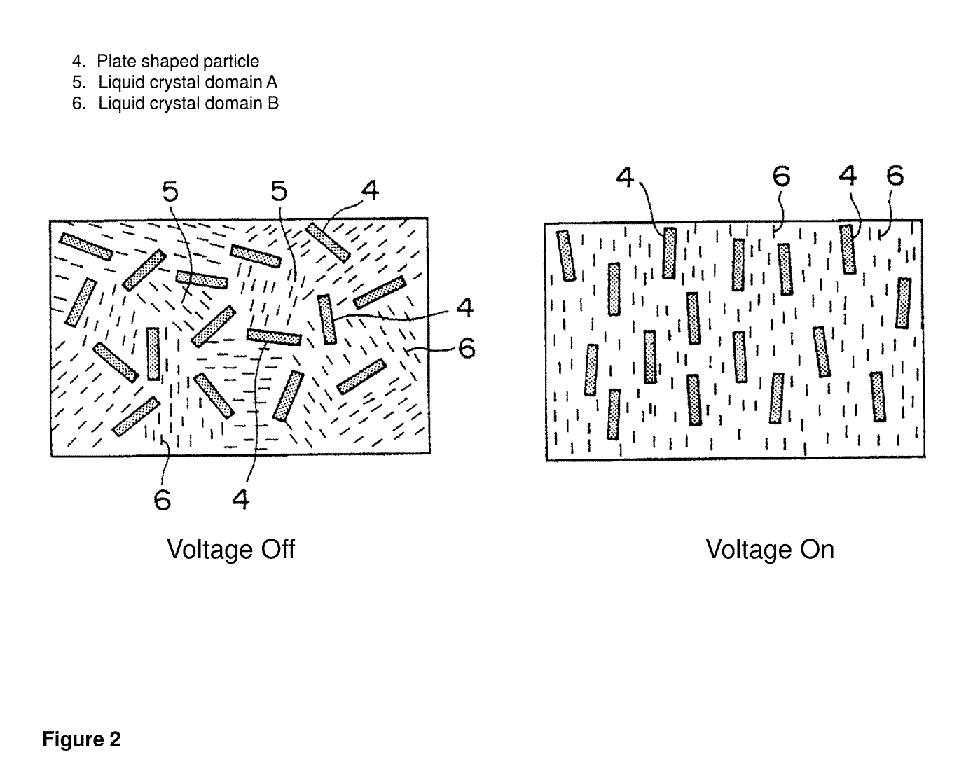

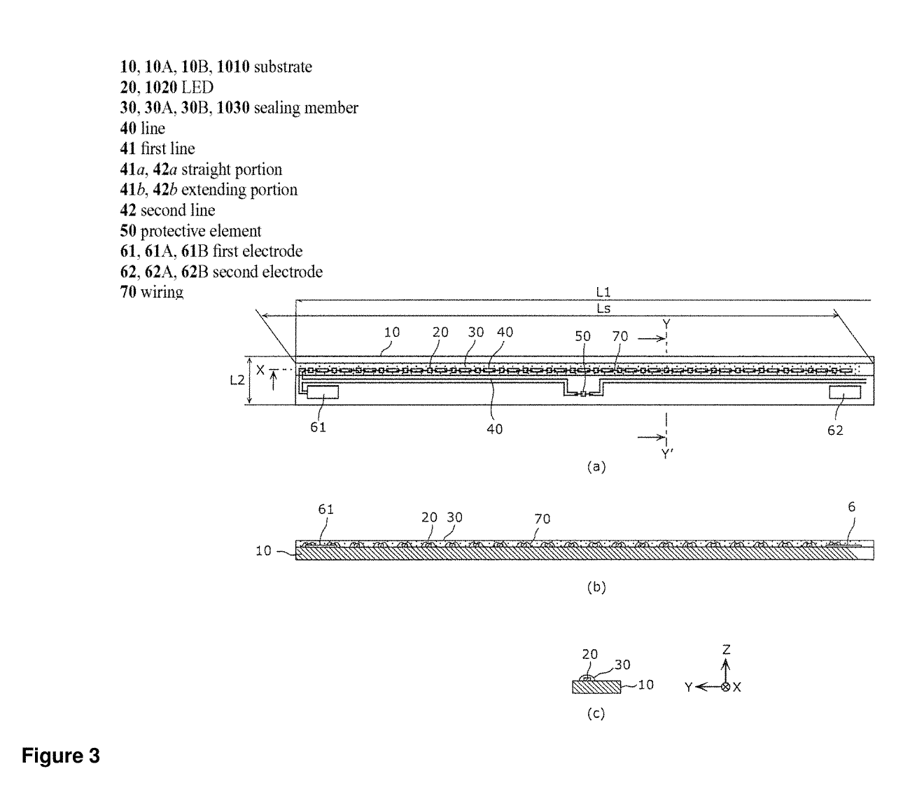

### DETAILED DESCRIPTION OF THE INVENTION

Three steps are necessary to solve the difficulties associated with implementing effective LED light fixtures. The first step is categorization of the LED light source shape. Light scattering/diffusion is dependent on the shape of the light source. In general, there are three shapes of LED light sources. Bullet type LED light bulbs typically have a small emission area, such as the approximately 5 mm square phosphor layer described in U.S. Pat. No. 7,144,763. Bullet type LED light bulbs are typically used in small area illumination applications such as LED back lights. Such applications typically require focused, rather than distributed, light patterns.

A second category of LED light bulbs are similar in shape to traditional incandescent light bulbs and are typically utilized as illumination stands or ceiling light fixtures as described in U.S. Pat. No. 8,439,527. This type of LED light bulb is used in both light focusing and light distribution applications.

A third category of LED light bulbs consists of arrays of bullet type LED light bulbs. Such LED light sources are widely used in a variety of applications including ceiling light fixtures, wall mount illumination lighting, automobile brake lighting, and others, as described in U.S. Pat. No. 7,086,756 and U.S. Pat. No. 9,000,679. Such applications typically require light diffusion to enlarge the light emission area beyond the original size of the LED array.

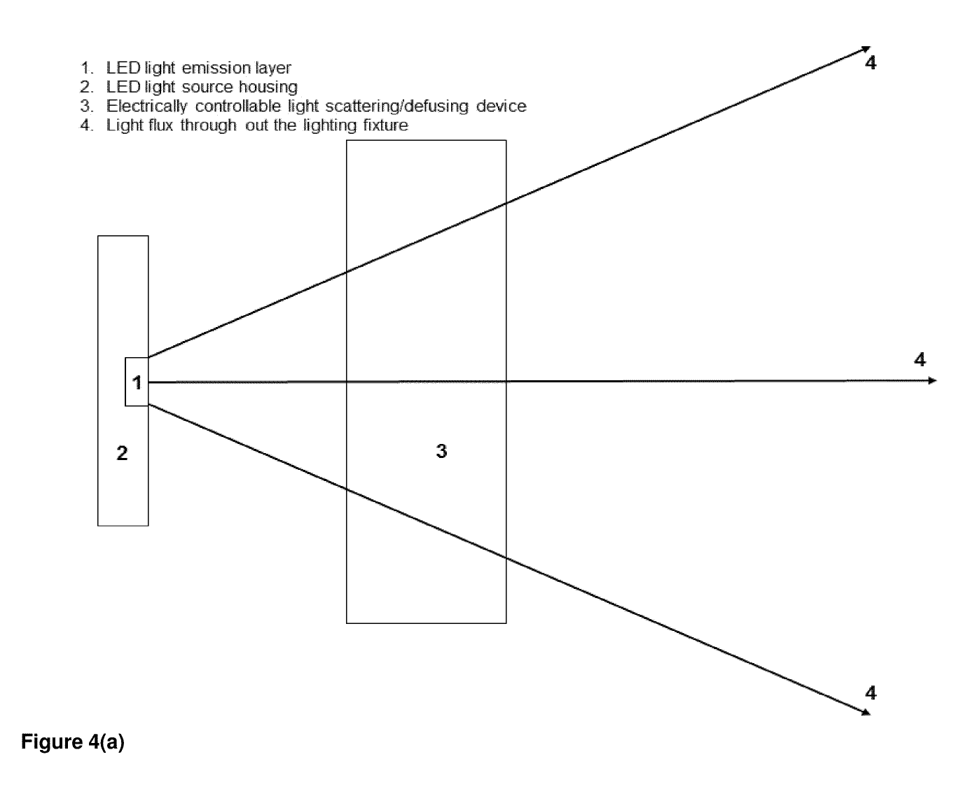

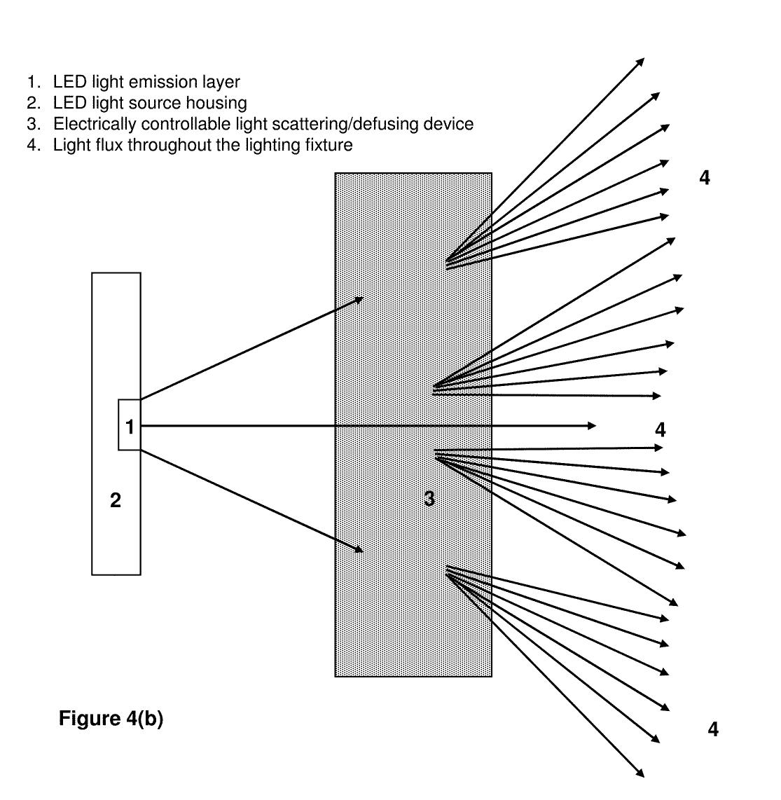

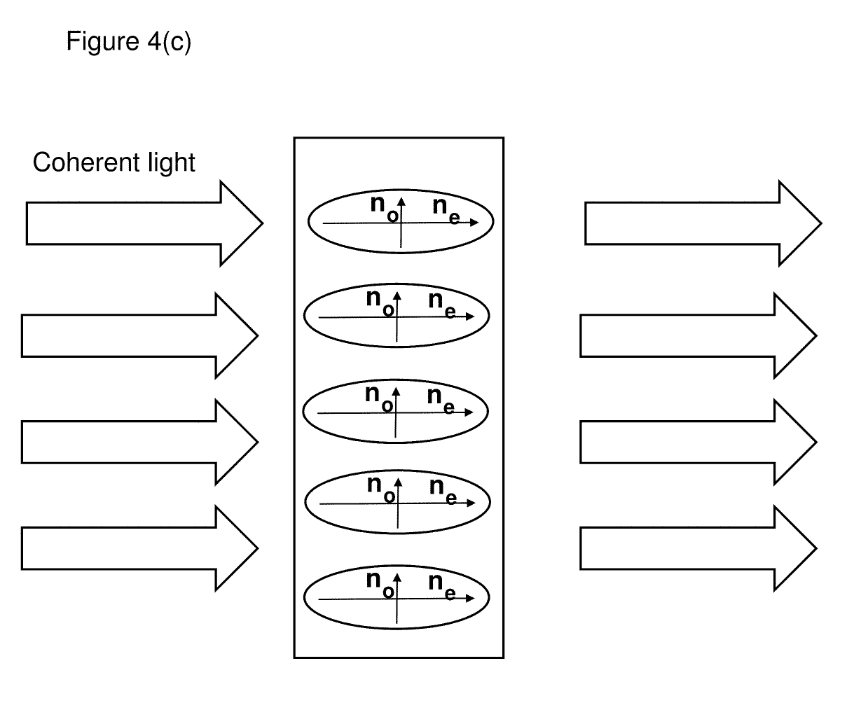

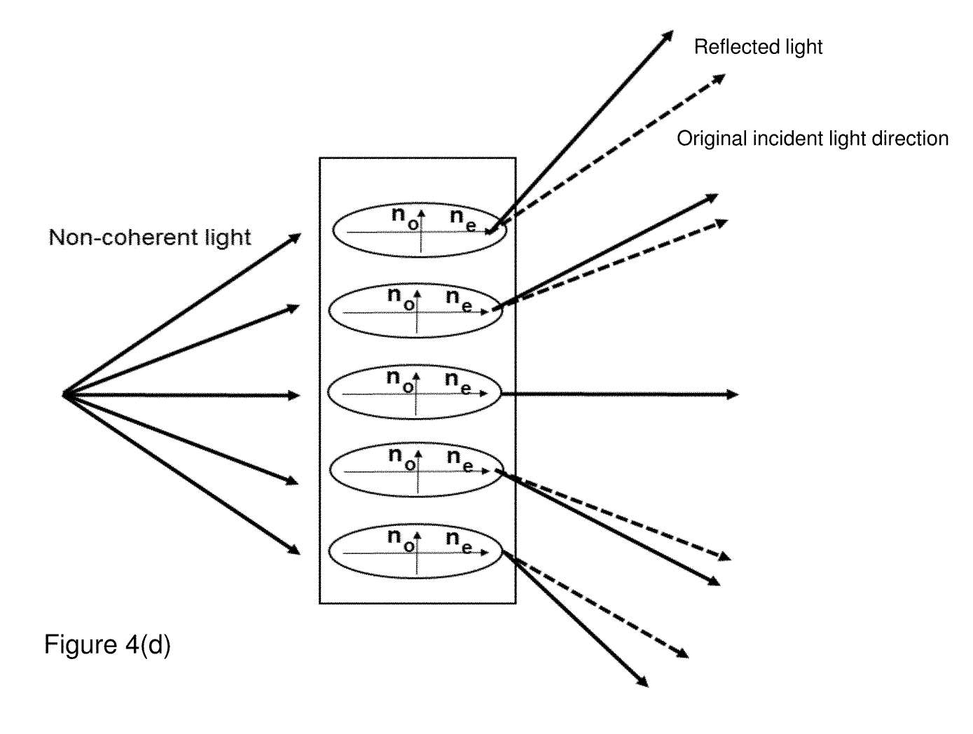

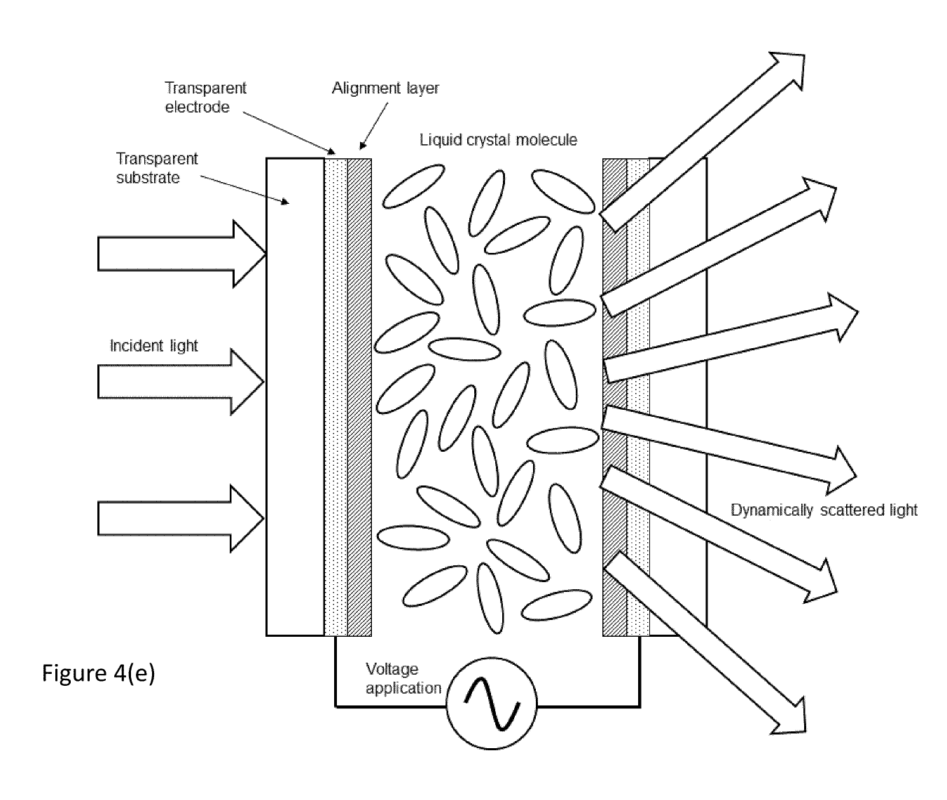

The second step is the design of light scattering/diffusion properties. This step comprises two considerations: general design, such as the general design of the device architecture, and specific design concept, such as selection of materials for device components. An embodiment of this invention uses a liquid crystal device to control the emission pattern of a light source. A light scattering liquid crystal device changes the light emission pattern by the light scattering/diffusion properties of the liquid crystal device. In the simplest case, light passes through the liquid crystal device with no scattering, as shown in FIG. 4(a). Incident light passes through a homeotropic liquid crystal alignment panel without any light scattering as shown in FIG. 4(c). Since all liquid crystal molecules align perpendicular to the substrates, incident light passes through the panel without light scattering. Note that, if all of the incident light flux is perpendicular to the substrates, incident light experiences extraordinary light refractive index from the liquid crystal layer, resulting in no refraction as shown in FIG. 4(c). However, if incident light has a different light direction flux, or non-coherent light, each direction of incident light flux experiences a slightly different effective refractive index when passing through the liquid crystal layer due to the birefringence of the liquid crystal layer, resulting in a function similar to a concave lens. Therefore, this type of homeotropic liquid crystal panel functions as a concave lens if incident light flux has continuous variation as shown in FIG. 4(d).

FIG. 4(e) illustrates dynamic light scattering by an electrically activated liquid crystal layer. Due to the electrical activation of the liquid crystal layer, a small current insertion creates a random type of liquid crystal alignment disturbance, resulting in light scattering, as shown in FIG. 4(e). This phenomenon is well known as dynamic scattering of a liquid crystal panel. Since this type of light scattering is dynamic in the time domain, but not by the spatial distribution of refractive indices, light scattering is very random in terms of spatial distribution. This also means that the expected light scattering pattern is much less dependent on spatial distribution compared to light scattering based on a spatial refractive indices pattern. Thus, the luminance and diffusion of light emitted from the LED light source may be controlled by electrically controlling the light scattering/diffusion property of the liquid crystal device. When the liquid crystal light diffusing device is activated by an external electric field as shown in FIG. 4(b), the original light from LED light emission source is scattered, resulting in a different light emission pattern as well as substantial dimming. The liquid crystal device may be comprised of a polymer dispersed liquid crystal display panel, a polymer network liquid display panel, a dynamic scattering mode liquid crystal display panel, a smectic A liquid crystal display panel, a nematic-cholesteric phase transition liquid crystal display panel or other embodiments. This embodiment does not restrict the use of any other light scattering type of liquid crystal devices capable of light scattering control by an externally applied electric field or current.

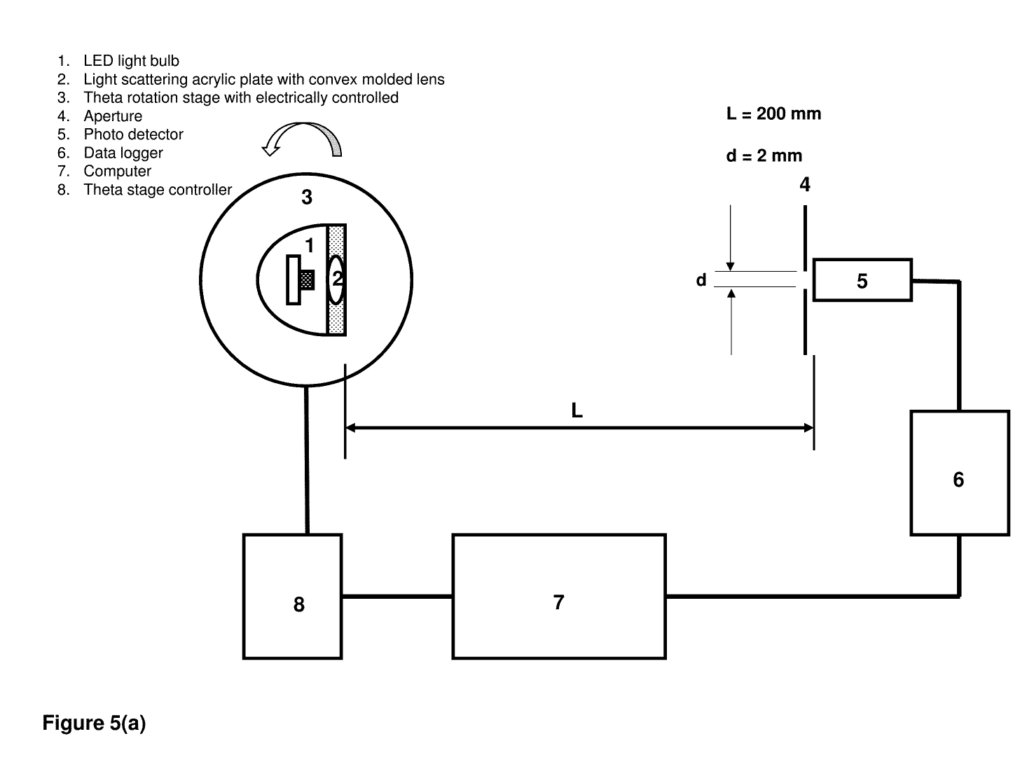

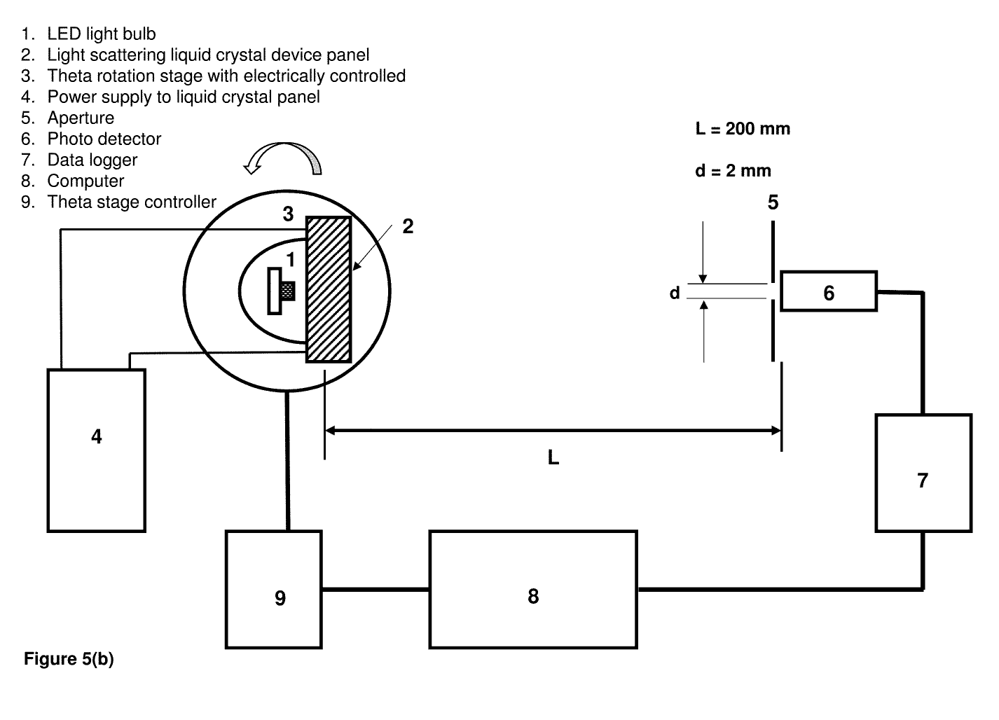

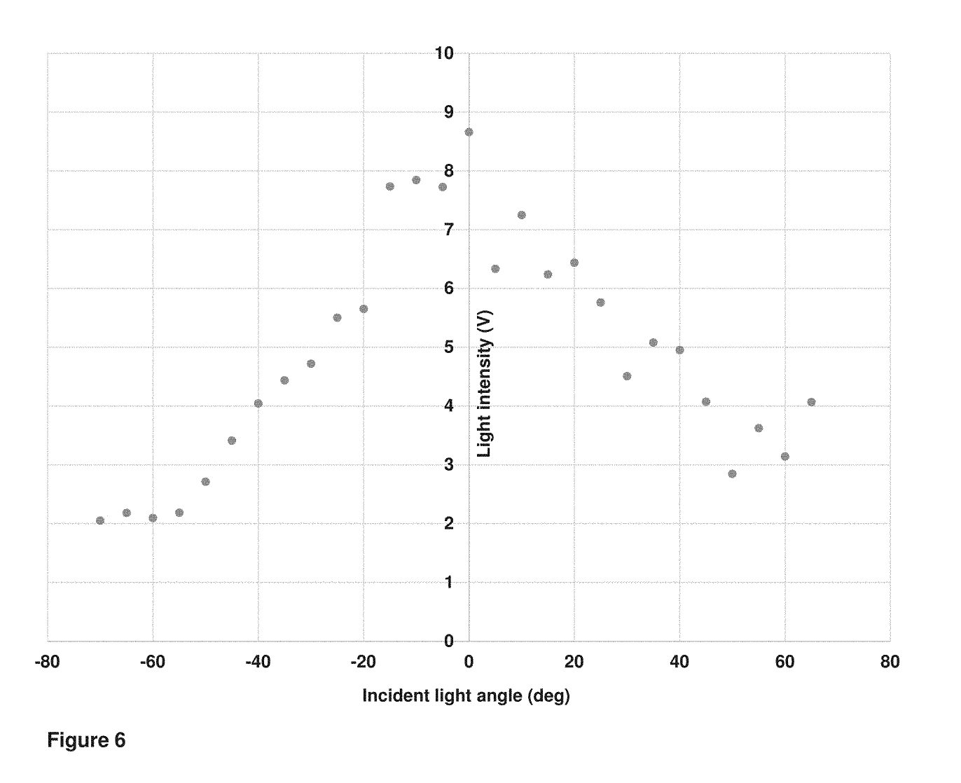

FIGS. 5(a) and 5(b) demonstrate the experimental setups used to test the concept and effect of this invention using a light scattering liquid crystal device in conjunction with a commercially available LED light bulb. FIG. 5(a) illustrates a light scattering/diffusion pattern measurement setup for a conventional LED light bulb using a convex, lens molded acrylic plate. As shown in FIG. 5(a), the LED light bulb may be rotated by an angle theta controlled by a servo motor. Emitted light flux may pass through an aperture set in front of a photo detector. The distance L represents the distance between the light emission surface of the LED light bulb and a detector aperture through a slit hole of the photo detector system having a diameter of 2 mm. The rotation angle of the LED light bulb may be set by a computer controlled rotation system and the LED light bulb may be rotated by steps of two degrees. The measurement set up of FIG. 5(a) allows the detection of an LED light bulb light emission pattern as a function of emission angle. The field view angle of L=200 mm and a detector aperture diameter of 2 mm creates a viewing angle of 0.0005 degrees which is small enough to discuss the light emission distribution of the LED light bulb. FIG. 6 shows the light distribution measurement results from the measurement set up shown in FIG. 5(a). As shown in FIG. 6, the emitted light from the LED light bulb is highly dependent on viewing angle. As shown in FIG. 6, the relative light intensity at an angle of 40 degrees from the up-light angle is 48.9% and the relative light intensity at an angle of 60 degrees from the up-light angle is 30% on average between clockwise and counterclockwise rotation. As shown in FIG. 6, light scattering is asymmetric between clockwise and counterclockwise rotations. Use of an electrically controlled, dynamic scattering device may suppress the effects of asymmetric light scattering. In the case of incandescent shaped LED light bulbs, the use of an electrically controllable light scattering diffusion device produces a more uniform light intensity distribution.

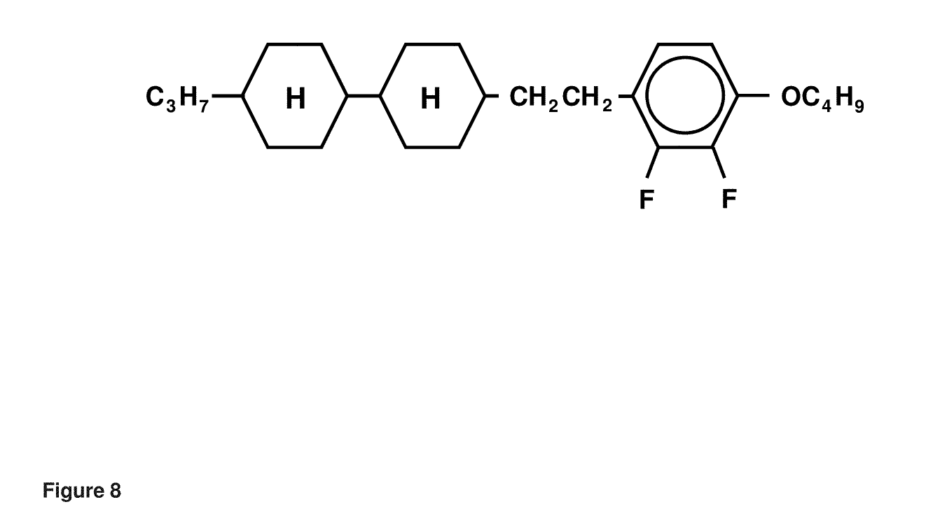

FIG. 5(b) illustrates a measurement setup of an embodiment of this invention having an actively controlled light scattering/diffusion device in front of the LED bulb without a light diffusing acrylic plate. The liquid crystal device in this embodiment has an 18 micron liquid crystal layer thickness, a one inch square aperture area for light intensity control, and a 120 nm think indium oxide transparent electrode. A 60 nm think polyimide liquid crystal alignment layer supplied by Nissan chemical known as SE-1121 induced homeotropic alignment. The liquid crystal layer is based on a commercially available liquid crystal mixture having negative anisotropy of dielectric constant supplied by Merck as Merck mixture 6883. To enhance the light scattering property of the liquid crystal device, 0.2 wt % of ammonium chloride may be doped as well as 1 wt % laterally replace fluorinated single liquid crystal component having the chemical formula shown in FIG. 8. The specific example shown in FIG. 8 is 4-trans-propyl bicyclohexane-[4′ trans ethyl-2,3 difluoro-butyloxybenzen]. This configuration enables the liquid crystal panel to work as a dynamic scattering mode device. Working concentration of ammonium chloride or any miscible organic salts to liquid crystal material is dependent on mutual miscibility between liquid crystal materials and a salt. In general, too much salt in liquid crystal mixture reduces a sufficiently stable function of the liquid crystal panel due to the ion migration effect and its potential erosion effect of the electrode. Therefore, regardless the miscibility limit, a minimum concentration of such salt is highly preferable. A typical concentration of such salt is up to 1 wt %, preferably up to 0.5 wt %, and more preferably up to 0.2 wt %. As long as a dynamic scattering phenomenon is induced, concentration of salt should be minimized. On the other hand, the laterally fluorinated liquid crystal component may be good to dope so long as it shows sufficient miscibility with the host liquid crystal mixture. In terms of concentration, the limitation is the influence on the nematic liquid crystal phase temperature range. The practical concentration is dependent on the host mixture's nematic liquid crystal phase temperature range. In most cases the preferable concentration of the type of fluorinated liquid crystal component shown in FIG. 8 is up to 10 wt %.

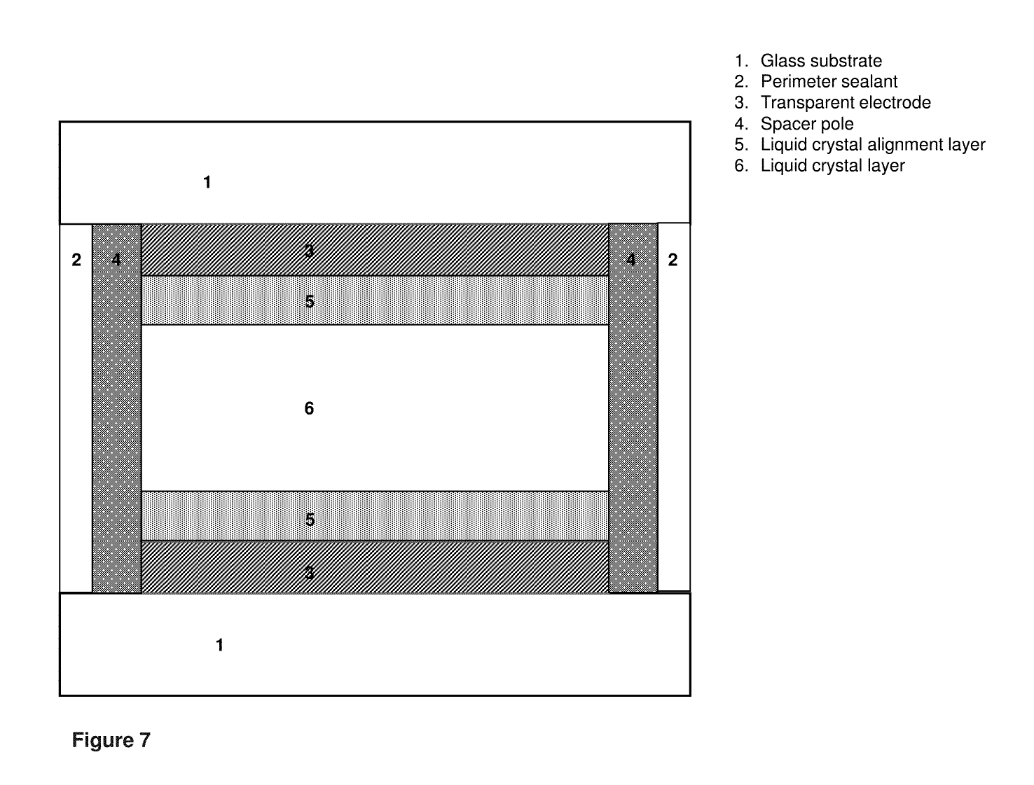

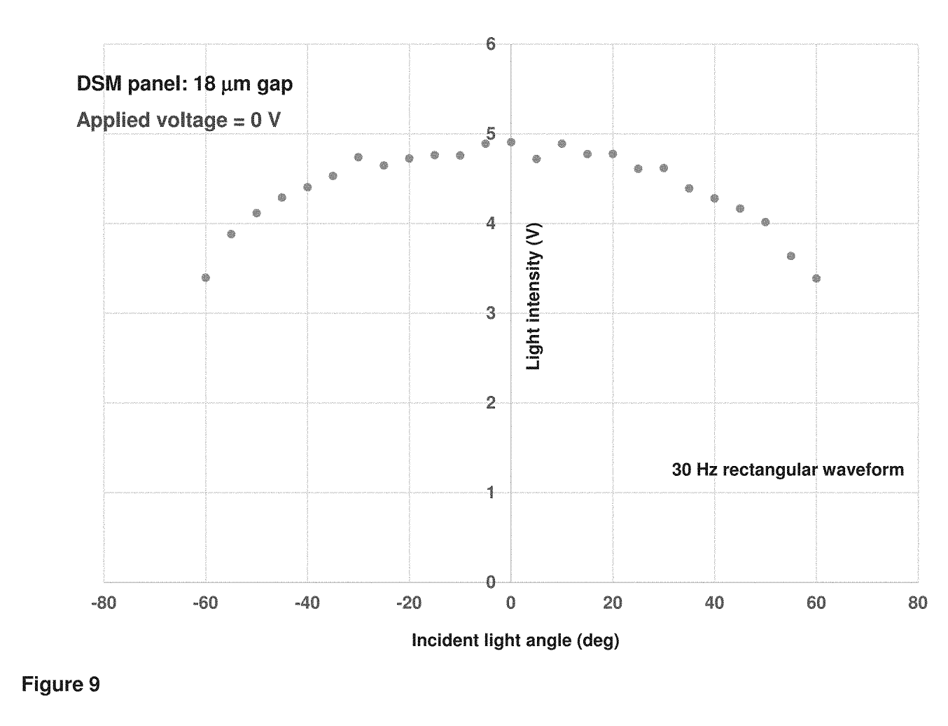

FIG. 9 shows light distribution measurements using the measurement setup of FIG. 5(b) when attaching the light scattering/diffusion liquid crystal device of FIG. 7 in front of the LED light bulb. As shown in FIG. 9, the relative light intensity at an angle of 40 degrees from the up-light angle is 89% and the relative light intensity at an angle of 60 degrees from the up-light angle is 70.7% on average between the clockwise and counterclockwise rotations.

Although FIG. 9 does not include active control of liquid crystal light scattering device with externally applied voltage, the light emission pattern of non-coherent light emission from an LED light source is partially adjusted by the non-light scattering state of the liquid crystal panel, which is described above with respect to FIG. 4(e). Since the liquid crystal panel used in the measurements shown in FIGS. 9 through 13 has homeotropic liquid crystal alignment, all liquid crystal molecules align vertically to the liquid crystal panel substrates when no external voltage is applied (FIG. 9). In this state, incident light feels the liquid crystal layer's refractive index mostly as an extraordinary refractive index. However, incident light emitted from the LED light source is non-coherent light, or has a certain distribution pattern emission. Depending on the actual incident light angle to the liquid crystal panel, each light flux originated from the LED light source feels a different effective refractive index at the liquid crystal layer. Integration of each light flux going through the liquid crystal panel creates a certain light distribution like a concave optical lens. Because of this concave lens effect at no voltage or non-activated homeotropic liquid crystal alignment state, the original LED light emission pattern has a wider and more uniform distribution as shown in FIG. 9. In addition to the non-activated liquid crystal panel effect due to the transparent concave lens effect, both light dimming and light distribution control is available once the transparent liquid crystal panel turns to light scattering mode. Therefore, light emission distribution control with refraction effect without light scattering is achieved.

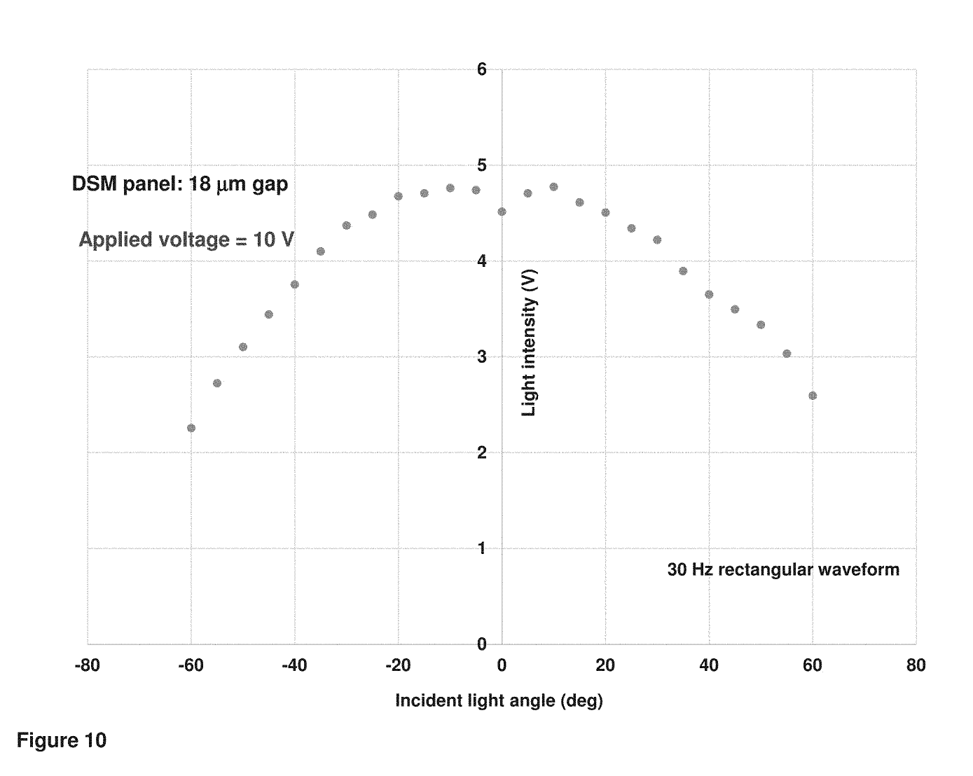

Application of driving voltages to the liquid crystal device of FIG. 7 changes the light distribution pattern, as shown in FIGS. 10 through 13. FIGS. 9 through 13 illustrate light distribution patterns that are more symmetric than with a conventional fixed light diffusing acrylic plate when the liquid crystal device is electrically controlled. As shown in FIG. 9 through 13, light emission from the LED light bulb is effectively distributed in a uniform manner. As shown in FIGS. 9 through 13, the light scattering/diffusing liquid crystal device also controls total light emission in the forward direction from the LED light bulb surface by adjusting the driving voltage of the light scattering/diffusing device.

In one embodiment, the driving voltage may be a 30 Hz rectangular waveform. Table 1 compares the diffusion pattern of a conventional acrylic light diffusing plate and a liquid crystal device. Table 1 illustrates a significant difference in light scattering/diffusion patterns as a function of viewing angle. The diffusion pattern of the liquid crystal device is more uniform across viewing angle than a conventional acrylic light diffusing plate with a concave lens.

Table 1 compares the light emission distribution pattern of an LED light bulb with a fixed acrylic light diffusing plate and an active light scattering/diffusing liquid crystal device with no applied voltage. In addition to a more uniform lighting effect, light emission distribution changes dramatically when the driving voltage applied to the liquid crystal device is adjusted.

TABLE 1
Light intensity distribution comparison
between conventional and this invention

| | Conventional fixed | DSM LC device |
|---|---|---|
| | defusing acrylic | without drive |
| | plate (control) | (this invention) |
| Up light angle (0 degree): 100% | 100% | 100% |
| 20 degree (clockwise) | 73.6% | 99.0% |
| 20 degree (counter clockwise) | 65.5% | 97.3% |
| 30 degree (clockwise) | 59.8% | 93.9% |
| 30 degree (counter clockwise) | 54.0% | 94.3% |
| 40 degree (clockwise) | 51.7% | 87.1% |
| 40 degree (counter clockwise) | 46.0% | 90.8% |
| 50 degree (clockwise) | 39.1% | 81.6% |
| 50 degree (counter clockwise) | 31.0% | 84.7% |
| 60 degree (clockwise) | 35.6% | 71.0% |
| 60 degree (counter clockwise) | 24.1% | 70.4% |

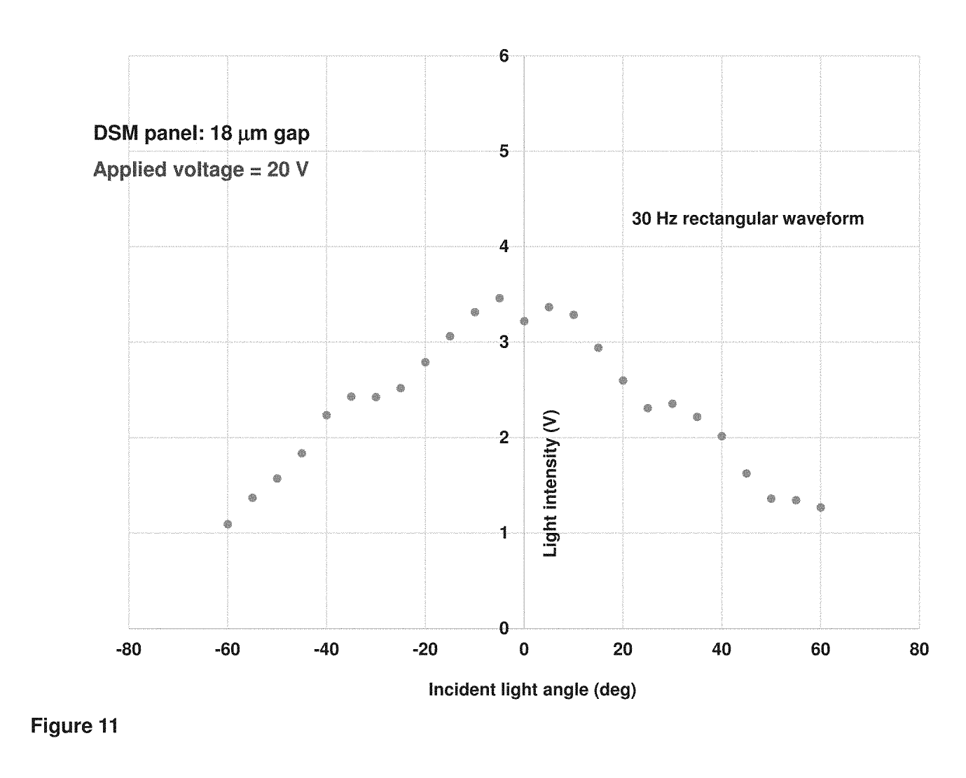

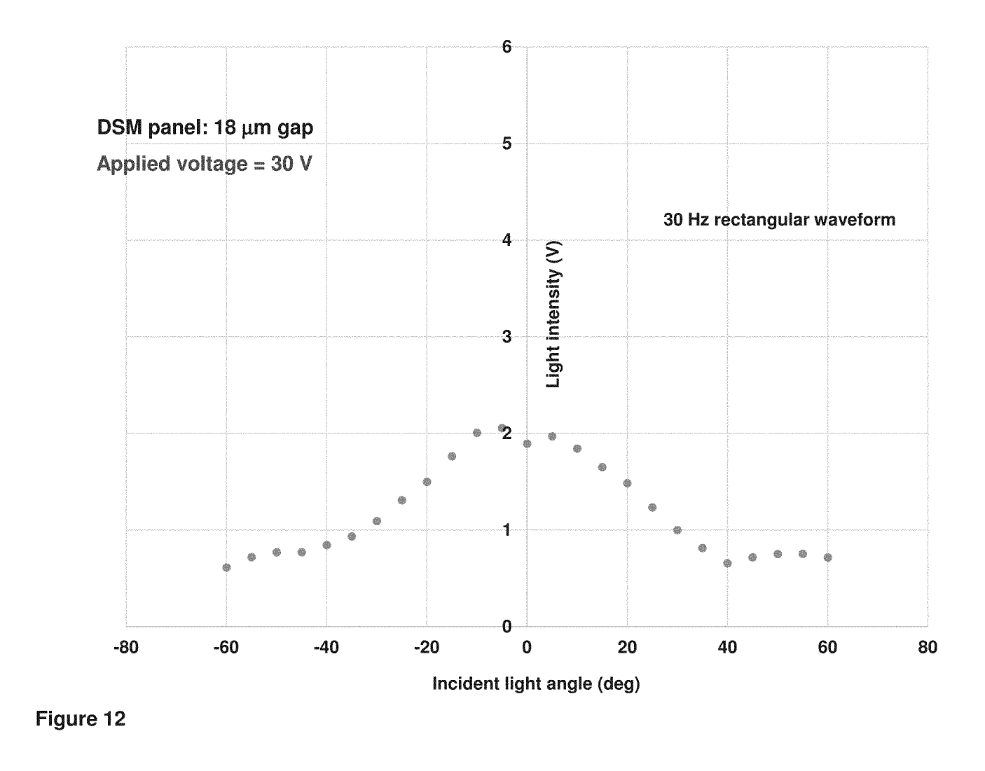

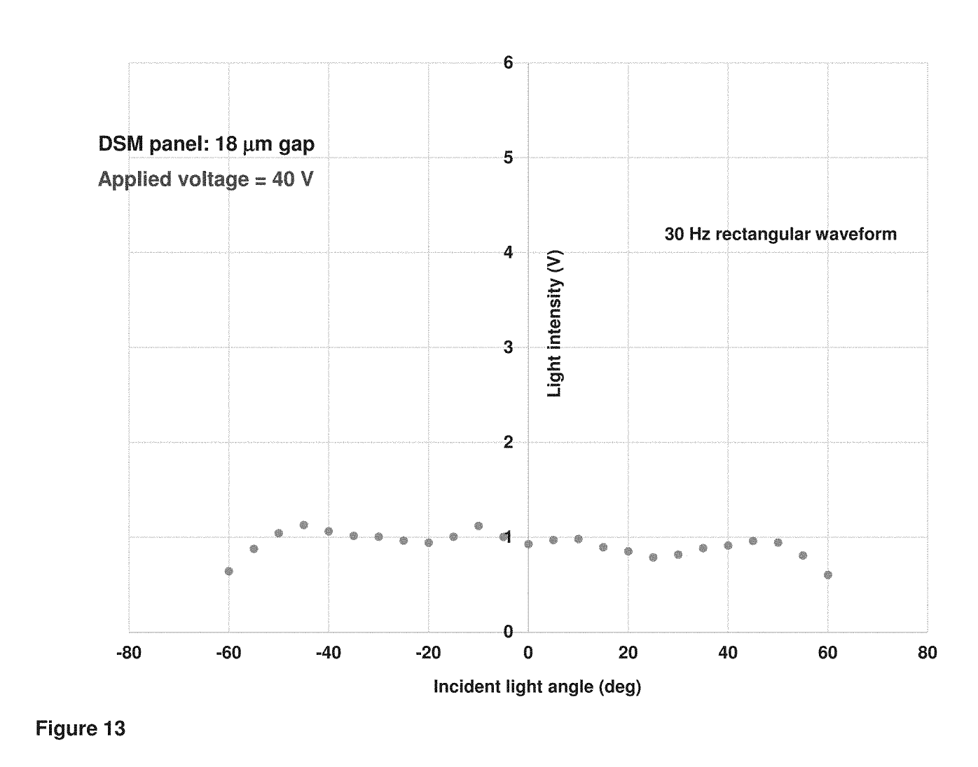

The light distribution pattern is more angle-dependent when a 20V driving voltage is applied, as shown in FIG. 11. The light distribution pattern is more angle-dependent and total light throughput is decreased when a 30V driving voltage is applied, as shown in FIG. 12. The light distribution pattern is uniform and total light throughput is reduced when a 40V driving voltage is applied, as shown in FIG. 13. Therefore, the electrically controllable light scattering/diffusion device of this embodiment allows for effective control of light distribution patterns and dimming.

One of the important property of a light scattering liquid crystal device is variable light scattering, allowing for electrical control of light scattering by the liquid crystal device. Dynamic scattering mode (DMS) provides random, dynamic, electrically controllable light scattering suitable for light fixture applications. Polymer dispersed liquid crystal (PDLC) or polymer network liquid crystal including stressed liquid crystal as disclosed in U.S. Pat. Nos. 8,054,413 and 7,034,907 are also applicable. Smectic A phase liquid crystal mixtures are also applicable. Smectic A phase liquid crystal mixtures allow for storage mode or memory mode drive, eliminating the need for continuous application of a driving voltage to sustain an adjusted light scattering pattern.

The final and the third step of is the optimization of light scattering/defusing properties of the light scattering/defusing device depending on the nature of the light source. As discussed above, this invention is applicable to several different shapes of LED light sources, such as bullet type single light emission sources, incandescent lamp shape light sources, and array(s) of single small area light emitters. This invention is optimized when it achieves the most effective way to control light emission distribution uniformly.

As discussed with the detailed experimental verification with use of a conventional single light emitter source LED light bulb, specific optimizations of its light scattering/defusing device are desirable. Even though such optimization is required, the concept of this invention and its result will not change. One features of this invention is directed to active control of light emission distribution patterns with an electrically controlled, light scattering type of liquid crystal device.

Therefore, for each optimization process depending on the nature of the LED light source, this section describes the design concept and its optimization procedure for three typical LED light source.

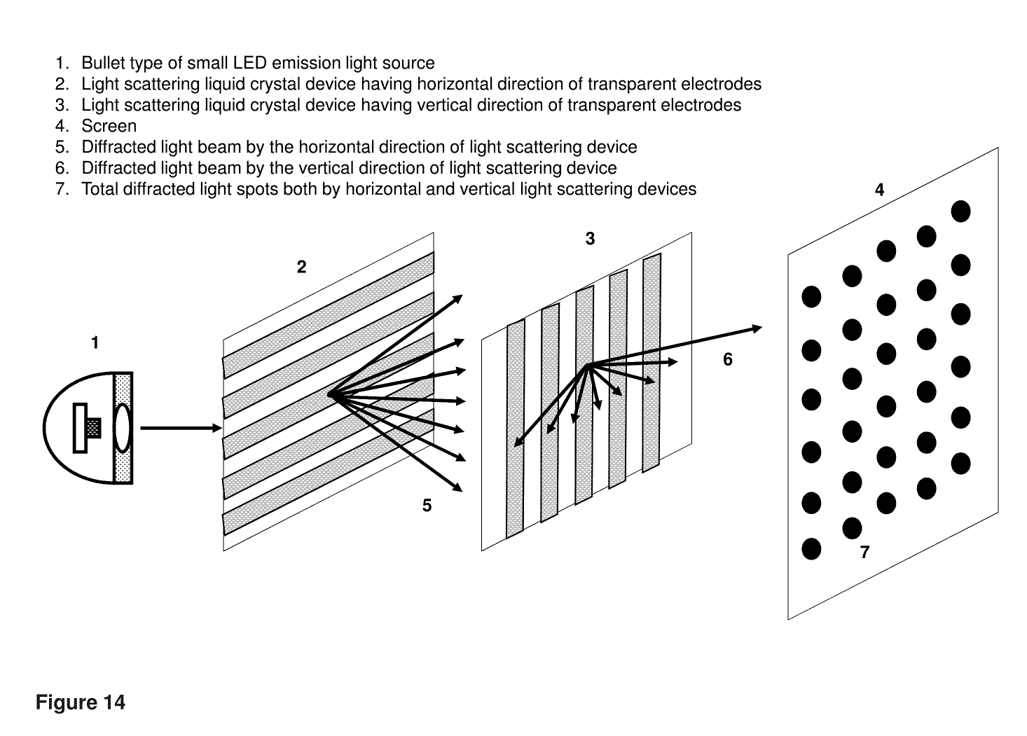

In one embodiment, the liquid crystal device may be used with a single small area emitter of approximately 5 mm square. In this case, a single electrode light scattering liquid crystal device up to approximately 10 mm square is applied. However, this case is not restricted to a single electrode liquid crystal panel. For a specific lighting purpose or illumination purpose, a specific patterned electrode liquid crystal device is also applicable. In such a case, it is possible to add an additional effect based on diffraction. Light diffraction and light scattering share some similarity, but these two phenomena are different. Light scattering occurs by a change in direction of the original light beam. Such changes are not limited to a single direction, but occur in multiple directions, resulting in light scattering. Light diffraction creates a specific change direction of from the original light direction. If a screen is placed at the opposite side of incident light transmitted in the direction of a light scattering plate, a periodic bright spots are observed. Therefore, using such a light diffraction property, a different configuration sharing the same concept as above enables the creation of a plurality of light spots from the single light spot of the original light source. This design concept is illustrated in FIG. 14. As shown in FIG. 14, this configuration provides different effect than the configuration of FIG. 7. Unlike the configuration of FIG. 7, the configuration of FIG. 14 creates multiple bright spots from a single bright spot of the original LED light emission. Although this effect is different from the primary purpose, i.e., to make a uniform and symmetric light emission distribution curve from spot like single light emission nature of LED light source, this result shares the same fundamental concept of an electrically controllable light emission distribution change. The configuration of FIG. 14 controls a single spot light source to create a two dimensional lattice shape of light sources. This is also one of the electrically controlled light emission distribution patterns.

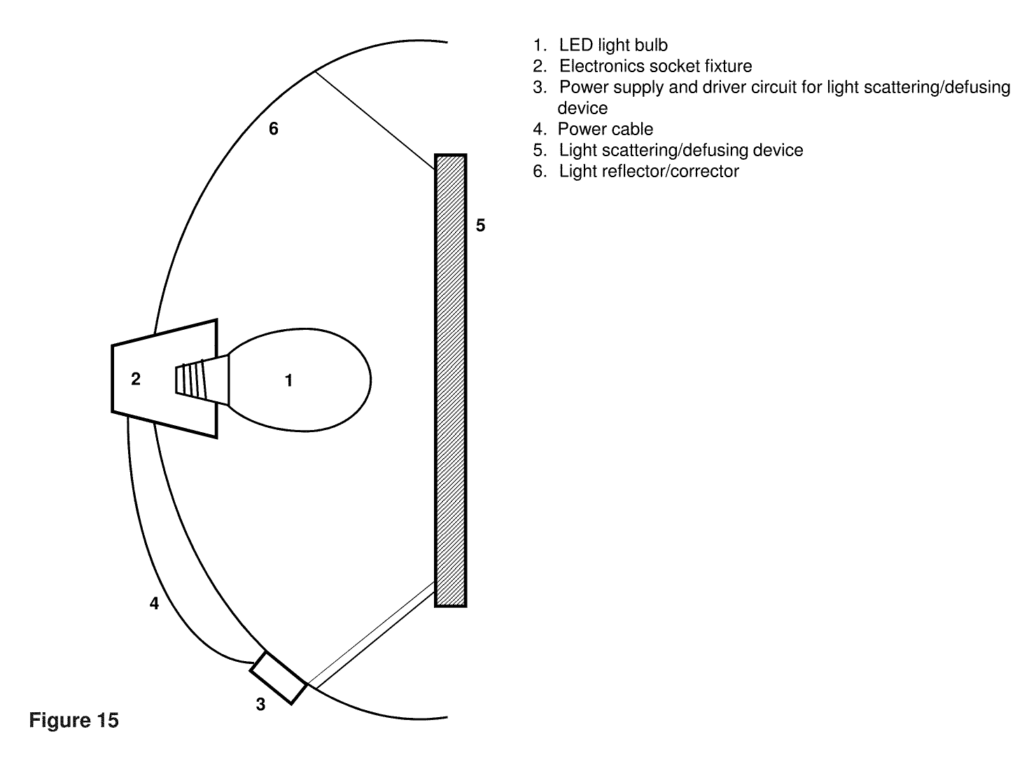

In another embodiment, the light scattering/diffusing liquid crystal device may be used with an LED light bulb having a shape similar to traditional incandescent bulbs, typically having an E26 socket. Such LED light bulbs typically have several single-emission LED dies in the bulb. Therefore, light emission from such bulbs is radial. The most efficient use of such a light bulb is with an external light reflector/corrector as well as an active, electrically controllable liquid crystal device, as illustrated in FIG. 15. In the configuration of FIG. 15, the distribution shape of the emitted light flux from the LED light bulb is changed depending on the light scattering/diffusion status of the liquid crystal device.

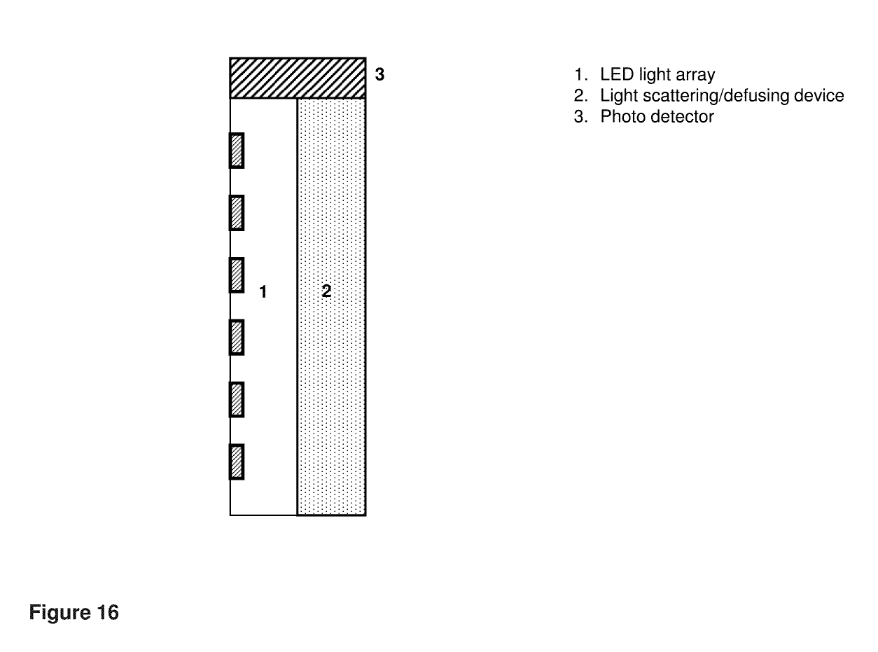

In yet another embodiment, the light scattering/diffusing liquid crystal device is used with an array of bullet type LED light bulbs. Linear arrays of LED light bulbs are widely used for both residential and commercial uses. Linear arrays, round arrays, and custom shapes of LED arrays are used for interior and exterior automobile lighting applications. Such arrays often result in bright spots at the location of each discrete LED bulb. However, in such applications, brightness is often more important than uniform light distribution. Therefore, adjustment of brightness in a linear or round shape LED array light fixture is a desirable function in most applications. For example, dynamic adjustment of the brightness of LED light arrays in an automobile head lamp is desirable based on driving conditions or the presence of oncoming traffic. The light scattering/diffusion liquid crystal device of this invention may also be used as a light emission distribution control device in conjunction with an ambient light detector as shown in FIG. 16. In FIG. 16, a photo detector may detect ambient light status automatically. Depending on a pre-set ambient light status condition, an automatically adjustable driving voltage may be applied to the liquid crystal device. The light scattering/diffusing device may change its light distribution pattern or transmission properties, resulting in a change of the light emission pattern from the LED array. When no voltage is applied to the liquid crystal device, light emitted from the LED array passes through the liquid crystal device with no diffusion, resulting in a plurality of bright spots corresponding to the location of each LED light bulb in the array. When a driving voltage is applied to the liquid crystal device, light scattering occurs, resulting in uniform light emission from the LED array. Depending on the applied voltage level, bright light spots to uniformly emitting rod-like emission are tunable.

When used in any of the above cases, this invention provides for additional practical functions. One example of such an enhanced feature is the use of this invention with an IR (Infra-Red) based remote control system, or Bluetooth. For example, the light scattering/defusing liquid crystal device is controlled remotely in the configuration shown in FIG. 15. Depending on the desired ambient light condition, using a remote control hands set, ambient light distribution and/or ambient light intensity is arbitrary controlled keeping the original LED light emission is constant. Such use is also suitable for dimming LED light bulbs without applying pulse width modulation or current control of LED light source, which may affect the hue or coloration of the LED light. Such emitting light distribution control and/or ambient light intensity control is also applicable without the use of an IR based remote control system.

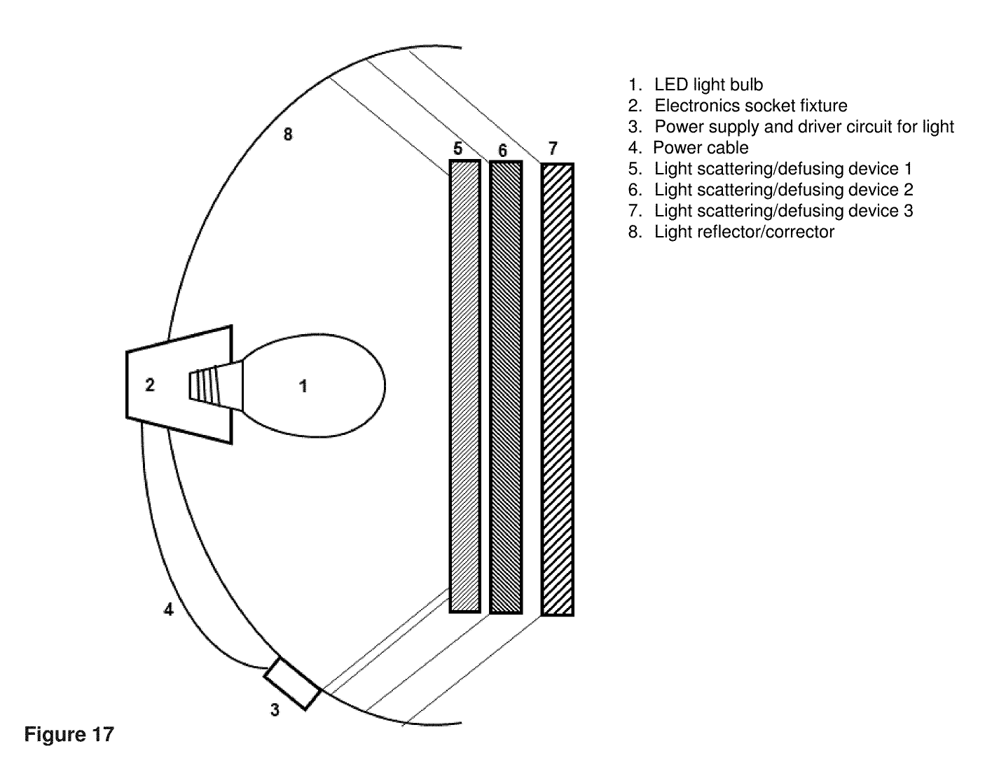

A plurality of light scattering/diffusing liquid crystal devices may be used with a single light source as shown in FIG. 17. Such a configuration allows for a larger dynamic range of intensity control including very dim ambient light control. Rather than a single light scattering/diffusing liquid crystal panel, two or more light scattering liquid crystal devices are used. In some cases, use of flexible substrates as a support for liquid crystal light scattering/diffusing device is effective. One example of such flexible substrates for this purpose is nickel based transparent electrode coated flexible substrate described in EP 2 829 907. Use of such transparent electrode coated flexible substrates for the embodiments above increases flexibility in shape and size of the light scattering/diffusing liquid crystal device and its performance. Shape and size of the light scattering/diffusing liquid crystal device are important factors in its light diffusion properties.

### Example 1 (Comparative Example)

A commercially available LED single light bulb having a convex lens and diffusing acrylic plate was used to evaluate its light emission distribution pattern. The light bulb was operated with 115 V, 60 Hz arbitrary current. Using the measurement set up of FIG. 5(a), the light emission distribution was measured. The light bulb was set on a computer controlled rotation stage. The rotation stage was rotated in 5 degree steps from the up-light position perpendicular to the photo detector of the diffusing acrylic plate as shown in FIG. 5(a). The photo detector measured light intensity at each five degree step and rotation angle. The measured light emission strength was quantified relative to the total light intensity at 0.005 degrees. This angle was determined by the distance between the emitting surface (top surface of the LED light bulb) and detector's surface through aperture. The distance between the light bulb surface and the detector surface was 200 mm. The aperture of the detector surface was 2 mm. The detection angle at each rotation stage angel was set with 0.005 degrees to detect sufficiently accurate angle dependence of the emitted light intensity from the LED light bulb including its equipped convex lens and light diffuser. At every angle, measured light intensity was sent to a computer. Angles measured by this system were both clockwise and counter clockwise 80 degrees from the original up-light position, defined as 0 degree. FIG. 6 was obtained light emitting distribution curb. FIG. 6 shows the light intensity measured at each angle. Although the actual measurement was from clockwise (positive direction in FIG. 6) 80 degrees to counter clockwise (negative direction in FIG. 6) 80 degrees, the LED light bulb did not show light emission over 70 degrees due to its internal structure. As shown in FIG. 6, the conventional LED light bulb having convex lens and acrylic defusing plate has uneven light emission over viewing angle. The relative emitting light intensity at 30 degrees compared to that of the up-light position (0 degree) was 59.8% at +30 degrees and 54.0% at −30 degrees, and 35.6% at +60 degrees and 24.1% at −60 degrees, as shown in Table 1. Therefore, this LED light bulb provides center focused light intensity and its relative emitting light intensity comes down to about 30% at a viewing angle of 60 degrees.

### Example 2 (an Embodiment of the Invention)

To confirm the performance of an embodiment of this invention in terms of uniform emitting light intensity and light intensity control, the convex lens and light defusing acrylic plate were taken out from the LED light bulb used in the measurement of Example 1 above. Using only the light emitting portion of the LED light bulb, the same light intensity dependence of viewing angle was measured with a light scattering/defusing liquid crystal device.

The liquid crystal device was prepared by the following process. The glass substrate was 45 mm by 55 mm, having nine independent transparent electrode pattern (10 mm×10 mm), 1.1 mm thick glass plate having indium oxide transparent electrode (60 nm thickness). The glass substrate was cleaned with high alkaline detergent, followed by a ten minute ultra-sonic application of isopropyl alcohol, and rinsed by deionized water for 10 minutes, and dried in a clean oven for 60 minutes at 110 C. The substrate was coated by a homeotropic liquid crystal induced alignment layer material by spin coating. The homeotropic alignment layer material was SE-1211 from Nissan Chemical (Japan). The alignment layer was cured for 60 minutes at 200 C in a clean oven. A liquid crystal layer gap was formed with using spacer particles. The ten micron spacing was formed with ten micron silicon dioxide spherical particles. Ten micron diameter spacer particles were dispersed using an electric charged gun in an electrostatic-proof plastic plate covered chamber. This process enabled uniform dispersion of the ten micron spacer particles on the glass substrate. The actual dispersion density on the glass substrate was 3 to 4 particles per 1 mm square area.

After spacer particles were dispersed, two substrates, one with dispersed spacer particles and one without, were laminated, placed in transparent plastic bags, and UV curable glue (Norland 68) was placed at the peripheral area of the laminated glass substrates. The bag was then put into vacuum sealer machine and sealed. After vacuum packed, the laminated panel was exposed to UV light with an i-line peak UV lamp. During this process, only 5 mm open area of UV curable sealant was left for filling with liquid crystal material. After UV cured, the vacuum-sealed bag was kept in a 60 C hold oven for a complete cure of the UV curable resin for 180 minutes. After complete curing, the laminated empty panel was filled with a liquid crystal mixture. The liquid crystal mixture was prepared using a commercially available negative dielectric anisotropy mixture (Merck 6883), 5 wt % doped with lateral direction fluorine inserted single liquid crystal material as shown in the chemical formula of FIG. 8 for higher birefringence. 0.2 wt % of ammonium chloride was doped for increased dynamic scattering performance of the liquid crystal panel. The mixed liquid crystal material was filled into the empty laminated panel using a vacuum filling method. After the liquid crystal mixture was filled, the excess amount of liquid crystal material was squeezed out using vacuum squeezing equipment. The liquid crystal material filling hole was sealed by the same UV curable glue.

This liquid crystal panel showed uniform homeotropic alignment when no external driving voltage was applied. When a 10 V, 30 Hz rectangular waveform voltage was applied, the liquid crystal panel showed dynamic scattering and turned milky white. When this dynamic scattering mode liquid crystal panel was placed in front of the LED light source prepared as described above in Example 2, the light emitting intensity was measured over across viewing angle using the set-up shown in FIG. 5(b). The same measurement method was used as with the measurement set up of FIG. 5(a). The measurement result is shown in FIGS. 9 to 13. As shown in FIG. 9, the light emitting intensity is more flat than that of the conventional LED light bulb of Example 1. Numerical comparison of the light emission distribution between a conventional LED light bulb (FIG. 6) and the embodiment described by this example (FIG. 9) is shown in Table 1. At a viewing angle of 30 degrees, the relative emitting intensity changed from 59.8% with a conventional LED light bulb to 93.9% with this embodiment at +30 degrees, and from 54.0% to 94.3% at −30 degrees (FIG. 9). At a viewing angle of 60 degrees, the relative emitting intensity between a conventional LED light bulb and this embodiment increased from approximately 30% to approximately 70%. This comparison demonstrates a significant uniform light emitting intensity effect of this embodiment.

Moreover, unlike conventional fixed light scattering/defusing acrylic plate technology, this embodiment also enables active control of light emitting strength distribution and dimming of a lighting fixture. For example, comparing FIG. 9 and FIG. 11, it is clear that application of a driving voltage of 20 V to the light scattering/defusing liquid crystal panel changed the light emitting distribution pattern significantly. Further increasing of the driving voltage reduced light intensity to less than 20% of the peal light intensity when no voltage was applied. Therefore, this embodiment enables not only more uniform light emitting intensity distribution, but also it enacts a dimming function.

The concept and structure of described above enable an electrically controlled emitting light intensity distribution for an LED light source or light bulb. This emitting light intensity distribution control provides two major benefits. First, it enables more uniform light scattering/defusing in terms of light intensity distribution. Second, it enables light intensity control, or dimming without sacrificing color hue or increasing power consumption. The uniform and controllable emitting light distribution function for an LED light source is achieved by the electrically controlled light scattering/defusing liquid crystal device. This device is easily added to existing LED light sources, either by the end user or the product supplier. Such flexible implementation enables utilization of this invention at low cost and with ease of installation.

1. A dynamic light scattering device, comprising:
a first substrate;
a second substrate; and
a layer of liquid crystal disposed between the first substrate and the second substrate,
wherein the layer of liquid crystal is configured to transmit light of less view-angle dependency when no voltage is applied between the first substrate and the second substrate than when a voltage is applied between the first substrate and the second substrate.

2. The dynamic light scattering device of claim 1, wherein the layer of liquid crystal is configured to transmit light of higher intensity when no voltage is applied between the first substrate and the second substrate than when a voltage is applied between the first substrate and the second substrate.

3. The dynamic light scattering device of claim 1, wherein the liquid crystal comprises a negative dielectric anisotropy liquid crystal, a polymer dispersed liquid crystal a polymer network liquid crystal or a sematic A phase liquid crystal.

4. The dynamic light scattering device of claim 1, wherein the liquid crystal comprises a negative dielectric anisotropy liquid crystal, a fluorinated liquid crystal and ammonium chloride.

5. The dynamic light scattering device of claim 4, wherein the liquid crystal is subject to homeotropic alignment.

6. A lighting device, comprising:
an LED light source; and
an electrically controlled light scattering device that receives and scatter light emitted from the LED light source,
wherein the electrically controlled light scattering device is configured to change a pattern of light scattering depending on a voltage applied to the electrically controlled light scattering device.

7. The lighting device of claim 6, wherein the electrically controlled light scattering device is configured to change an intensity of light emitted from the lighting device depending on a voltage applied to the electrically controlled light scattering device.

8. The lighting device of claim 6, wherein the electrically controlled light scattering device comprises a layer of liquid crystal.

9. The lighting device of claim 8, wherein the liquid crystal comprises a negative dielectric anisotropy liquid crystal, a polymer dispersed liquid crystal a polymer network liquid crystal or a sematic A phase liquid crystal.

10. The lighting device of claim 8, wherein the liquid crystal comprises a negative dielectric anisotropy liquid crystal, a fluorinated liquid crystal and ammonium chloride.

11. The lighting device of claim 10, wherein the liquid crystal is subject to homeotropic alignment.

12. The lighting device of claim 6, further comprising a remote control system to control the electrically controlled light scattering device.

13. The lighting device of claim 6, further comprising an ambient light detector that detects level of ambient light to control the electrically controlled light scattering device.

14. A dynamic light scattering device, comprising:
a first substrate;
a second substrate; and
a layer of liquid crystal disposed between the first substrate and the second substrate,
wherein the layer of liquid crystal is configured to operate as a concave lens when no voltage is applied between the first substrate and the second substrate and to operate as a light scattering medium when a voltage is applied between the first substrate and the second substrate.
